(19) United States
(12) Patent Application Publication
(10) Pub. No.: US 2020/0179957 A1
(43) Pub. Date: Jun. 11, 2020

(54) CONNECTION STRUCTURE FOR SHOWER ASSEMBLY

(71) Applicant: Runner (Xiamen) Corp., Xiamen (CN)

(72) Inventors: WEN-HUA YE, Xiamen (CN); HUAN-LONG HUANG, Xiamen (CN); CAN-KUN WU, Xiamen (CN); SHENG-CHAO DAI, Xiamen (CN)

(21) Appl. No.: 16/703,653

(22) Filed: Dec. 4, 2019

(30) Foreign Application Priority Data
Dec. 5, 2018 (CN) 201811481600.9

(51) Int. Cl. B05B 1/18

(52) U.S. Cl. CPC B05B 1/185

(57) ABSTRACT

A connection structure for assembling shower, that includes: a shower, on which is disposed a first connection hanging piece; and a shower head, on which is disposed a second connection hanging piece connected in cooperation with the first connection hanging piece, such that the first connection hanging piece and the second connection hanging piece are connected and hung in cooperation, to realize connection of the shower with the shower head. For this connection structure, the shower can be placed conveniently on the shower head, and it can be produced easily, to achieve good economic results.

### BACKGROUND OF THE INVENTION

### Field of the Invention

The preferred embodiment of the present invention relates to a connection structure, and in particular to a connection structure for a shower assembly.

### The Prior Arts

Presently on the market, the shower is assembled by means of hook connection, socket port insertion, and magnetic attraction. However, these types of assembly require rather complicate structure, and that is difficult to manufacture. In application, the shower must be inserted and hung into the shower head with a high degree of precision to achieve secure connection. Moreover, since the shower is placed into the shower head in hooking cooperation, such that in detaching, greater force is required to separate them from each other.

Therefore, presently, the design and performance of the shower connection structure is not quite satisfactory, and it leaves much room for improvement.

### SUMMARY OF THE INVENTION

In view of the problems and drawbacks of the prior art, the preferred embodiment of the present invention provides a connection structure for a shower assembly, to overcome the shortcomings of the Prior Art.

The present invention provides a connection structure for assembling shower, comprising: a shower, on which is disposed a first connection hanging piece; and a shower head, on which is disposed a second connection hanging piece connected with the first connection hanging piece, such that the first connection hanging piece and the second connection hanging piece are connected and hung in cooperation, to realize connection of the shower to the shower head.

In an aspect of the present invention, the connection structure for assembling shower as claimed in claim 1, wherein the first connection hanging piece includes a hanging arm hook, the second connection hanging piece includes a main body, and a ring shape hole is disposed on the main body; a first portion of the hanging arm hook is connected to the shower and a second portion of the hanging arm hook is inserted into the ring shape hole to realize connection in cooperation.

In another aspect of the present invention, the main body is indented from top to bottom to form the ring shape hole, the second portion of the hanging arm hook is inserted from top to bottom of the ring shape hole, the first portion of the hanging arm hook is in contact cooperation with the main body in the ring shape hole.

In yet another aspect of the present invention, one end of the second portion is inserted into the ring shape hole, the other end of the second portion is connected to the first portion to form into a body, a cross section of the second portion increases gradually from one end to the other end.

In a further aspect of the present invention, the second connection hanging piece includes a hanging arm hook, and the first connection hanging piece includes a main body, a ring shape hole is disposed on the main body; a first portion of the hanging arm hook is connected to the shower head, and a second portion of the hanging arm hook is inserted into the ring shape hole to realize connection in cooperation.

In another aspect of the present invention, the main body is indented from top to bottom to form the ring shape hole, the ring shape hole is hung from top to bottom around the second portion of the hanging arm hook, the first portion of the hanging arm hook is in contact cooperation with the main body in the ring shape hole.

In yet another aspect of the present invention, one end of the second portion is inserted into the ring shape hole, the other end of the second portion is connected to the first portion to form into a body, a cross section of the second portion increases gradually from one end to the other end.

Compared with the existing technology, the present invention has the advantages that it can be produced in a short period of time, and it can be mass produced. Further, its connection approach is novel and quite unique, to achieve stable and reliable connection and structure.

Further scope of the applicability of the present invention and embodiments thereof will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

Embodiments of the present invention are described below, by way of example only, with reference to the accompanying drawings; in which:

FIG. 1 is a schematic diagram of a connection structure for a shower assembly according to the present invention; and

FIG. 2 is another schematic diagram of a connection structure for a shower assembly according to the present invention.

### DETAILED DESCRIPTION OF THE PREFERRED EMBODIMENT

The purpose, construction, features, functions and advantages of the present invention and its embodiments can be appreciated and understood more thoroughly through the following detailed descriptions with reference to the attached drawings.

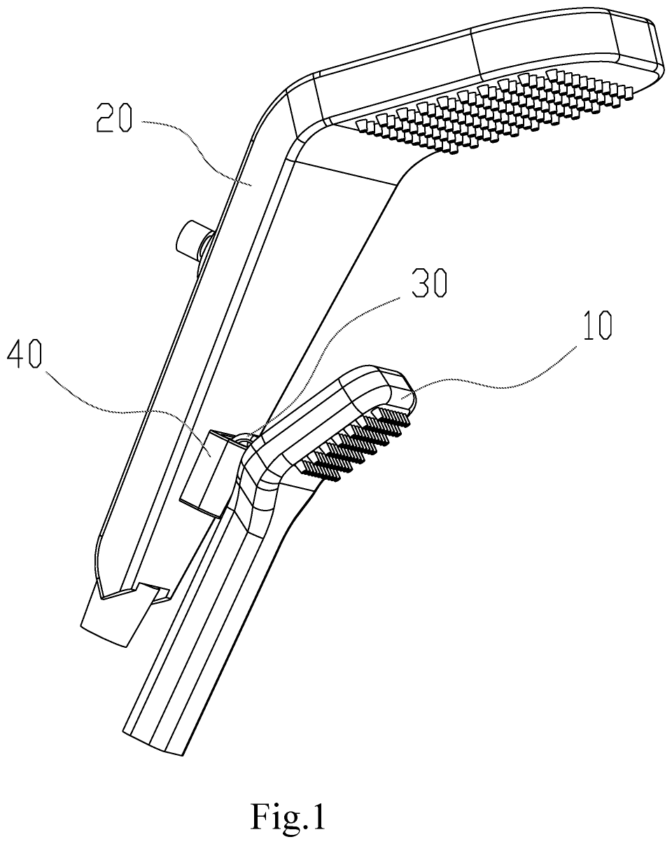

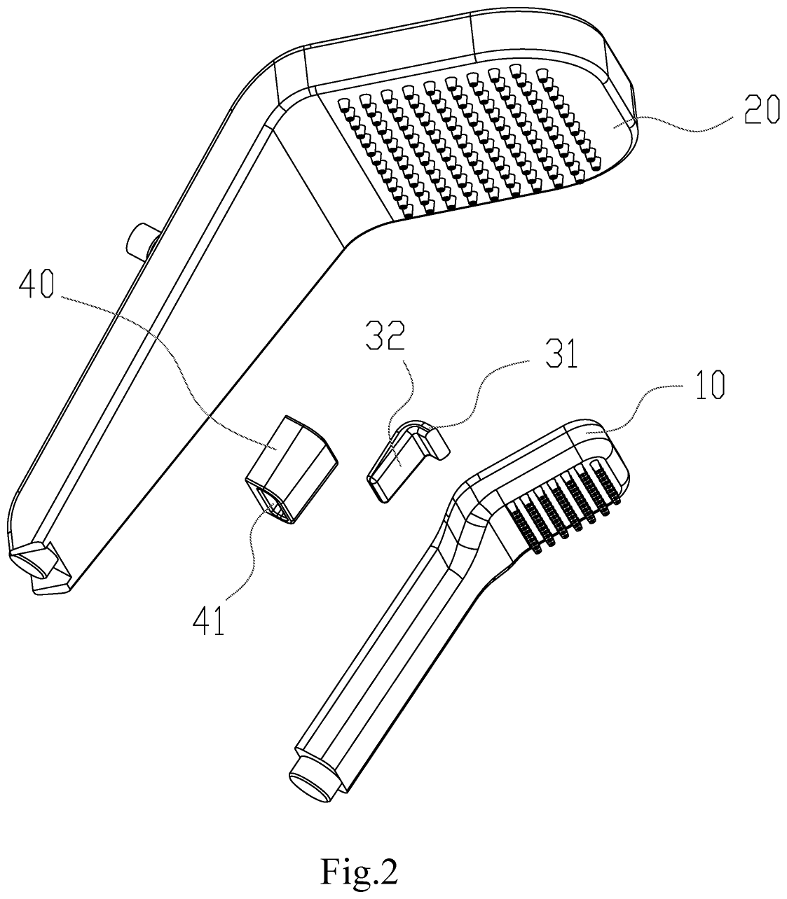

Refer to FIGS. 1 to 2 respectively for a schematic diagram of a connection structure for a shower assembly according to the present invention; and another schematic diagram of a connection structure for a shower assembly according to the present invention.

As shown in FIGS. 1 to 2, the present invention provides a connection structure for assembling shower, comprising: a shower 10, on which is disposed a first connection hanging piece 30; and a shower head 20, on which is disposed a second connection hanging piece 40 connected with the first connection hanging piece 30, such that the first connection hanging piece 30 and the second connection hanging piece 40 are connected and hung in cooperation, to realize connection of the shower 10 to the shower head 20. The present invention realizes the hanging and connection of the shower 10 and the shower head 20, without the need of hook connection of the existing technology, to make the hanging and taking off the shower more easily and conveniently.

In the present invention, the hanging connection of the shower and shower head can be achieved in a plurality of ways, in the following, two embodiments are described to explain the features and characteristics of the present invention.

### Embodiment 1

In the first embodiment of the present invention, the first connection hanging piece 30 includes a hanging arm hook, the second connection hanging piece 40 includes a main body, and a ring shape hole 41 is disposed on the main body. Wherein, the ring shape hole 41 may or may not penetrate through the whole main body. A first portion 31 of the hanging arm hook is connected to the shower 10, and a second portion 32 of the hanging arm hook is inserted into the ring shape hole 41 to realize connection in cooperation.

The main body is indented from top to bottom to form the ring shape hole 41, the second portion 32 of the hanging arm hook is inserted from top to bottom of the ring shape hole 41, the first portion 31 of the hanging arm hook is in contact cooperation with the main body in the ring shape hole 41.

One end of the second portion 32 is inserted into the ring shape hole 41, the other end of the second portion 32 is connected to the first portion 31 to form into a body, a cross section of the second portion 32 increases gradually from one end to the other end.

In the first embodiment, the second connection hanging piece 40 is disposed on an end face in the direction for water output of the shower head, and the first connection hanging piece 30 is disposed on an end face in the opposite direction for the water output of the shower. The first connection hanging piece 30 and the second connection hanging piece 40 can be produced separately, then they are used to fix the shower head and shower together. Or alternatively, the first connection hanging piece 30 and the second connection hanging piece 40 can be produced together with the shower or the shower head, to form into a body respectively.

To be more specific, for a shower assembly having two or more water outputs, for example as mentioned above, the shower and shower head may have their own water output structure, the shower can be fixed onto the shower head by using a hanging hook. The hang hook ring can be an open ring or a closed ring. Or the shower may have a ring, and the shower head may have a hook; to hook on a back side of the shower, or a belly portion of the shower head; but the present invention is not limited to this. In an embodiment of the present invention, the shower and shower head may have a similar shape.

### Embodiment 2

The second embodiment is similar to the first embodiment, with slight differences of dispositions of elements (not shown in the drawings).

In the second embodiment, the second connection hanging piece 40 includes a hanging arm hook, and the first connection hanging piece 30 includes a main body, a ring shape hole 41 is disposed on the main body; a first portion 31 of the hanging arm hook is connected to the shower head 20, and a second portion 32 of the hanging arm hook is inserted into the ring shape hole 41 to realize connection in cooperation.

The main body is indented from top to bottom to form the ring shape hole 41, the ring shape hole 41 is hung from top to bottom around the second portion 32 of the hanging arm hook, the first portion 31 of the hanging arm hook is in contact cooperation with the main body in the ring shape hole 41.

One end of the second portion 32 is inserted into the ring shape hole 41, the other end of the second portion 32 is connected to the first portion 31 to form into a body, a cross section of the second portion 32 increases gradually from one end to the other end.

More specifically, in the present invention, the first connection hanging piece 30 is provided on the shower, and the first connection hanging piece 30 can be made integrally on the shower depending on actual requirement. While the second connection hanging piece 40 is provided on the shower head to act in cooperation with the first connection hanging piece 30, and the second connection hanging piece 40 can be made integrally on the shower head depending on actual requirement.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A connection structure for assembling shower, comprising:
a shower, on which is disposed a first connection hanging piece; and
a shower head, on which is disposed a second connection hanging piece connected with the first connection hanging piece, such that the first connection hanging piece and the second connection hanging piece are connected and hung in cooperation, to realize connection of the shower to the shower head.

2. The connection structure for assembling shower as claimed in claim 1, wherein the first connection hanging piece includes a hanging arm hook, the second connection hanging piece includes a main body, and a ring shape hole is disposed on the main body; a first portion of the hanging arm hook is connected to the shower, and a second portion of the hanging arm hook is inserted into the ring shape hole to realize connection in cooperation.

3. The connection structure for assembling shower as claimed in claim 2, wherein the main body is indented from top to bottom to form the ring shape hole, the second portion of the hanging arm hook is inserted from top to bottom of the ring shape hole, the first portion of the hanging arm hook is in contact cooperation with the main body in the ring shape hole.

4. The connection structure for assembling shower as claimed in claim 3, wherein one end of the second portion is inserted into the ring shape hole, the other end of the second portion is connected to the first portion to form into a body, a cross section of the second portion increases gradually from one end to the other end.

5. The connection structure for assembling shower as claimed in claim 1, wherein the second connection hanging piece includes a hanging arm hook, and the first connection hanging piece includes a main body, a ring shape hole is disposed on the main body; a first portion of the hanging arm hook is connected to the shower head, and a second portion of the hanging arm hook is inserted into the ring shape hole to realize connection in cooperation.

6. The connection structure for assembling shower as claimed in claim 5, wherein the main body is indented from top to bottom to form the ring shape hole, the ring shape hole is hung from top to bottom around the second portion of the hanging arm hook, the first portion of the hanging arm hook is in contact cooperation with the main body in the ring shape hole.

7. The connection structure for assembling shower as claimed in claim 6, wherein one end of the second portion is inserted into the ring shape hole, the other end of the second portion is connected to the first portion to form into a body, a cross section of the second portion increases gradually from one end to the other end.
